(19) United States
(12) Patent Application Publication
(10) Pub. No.: US 2005/0084797 A1
(43) Pub. Date: Apr. 21, 2005

(54) Heat-sensitive lithographic printing plate precursor

(75) Inventors: Joan Vermeersch, Deinze (BE); Sue Wilkinson, Antwerpen (BE); Dirk Kokkelenberg, St. Niklass (BE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: AGFA-GEVAERT, Mortsel (BE)

(21) Appl. No.: 10/960,466

(22) Filed: Oct. 7, 2004

Related U.S. Application Data
(60) Provisional application No. 60/514,772, filed on Oct. 27, 2003.

(30) Foreign Application Priority Data
Oct. 16, 2003 (EP) 03103827.6

(51) Int. Cl. G03C 3/00

(52) U.S. Cl. 430/270.1

(57) ABSTRACT

A heat sensitive lithographic printing plate precursor comprising in the order given (i) a lithographic base having a hydrophilic surface, (ii) an image recording layer comprising hydrophobic thermoplastic polymer particles and (iii) a contrast layer, wherein the precursor comprising an infrared absorbing compound present in at least one of said image recording layer or contrast layer and wherein the contrast layer further comprises a colorant capable of providing a visible image after exposure and development of the precursor and wherein the image recording layer is substantially free of the colorant. The printing plate formed after image-wise exposing and processing exhibits an improved image-contrast and reduced staining.

### CROSS-REFERENCE TO RELATED PATENT APPLICATIONS

This application claims the benefit of U.S. Provisional Application No. 60/514,772 filed Oct. 27, 2003, which is incorporated by reference. In addition, this application claims the benefit of European Application No. 03103827.6 filed Oct. 16, 2003, which is also incorporated by reference.

### FIELD OF THE INVENTION

The present invention relates to a heat sensitive lithographic printing plate precursor, comprising an infrared absorbing compound, and wherein a colorant is further present in a separate layer on an image recording layer.

### BACKGROUND OF THE INVENTION

In lithographic printing, a so-called printing master such as a printing plate is mounted on a cylinder of the printing press. The master carries a lithographic image on its surface and a printed copy is obtained by applying ink to said image and then transferring the ink from the master onto a receiver material, which is typically paper. In conventional, so-called “wet” lithographic printing, ink as well as an aqueous fountain solution (also called dampening liquid) are supplied to the lithographic image which consists of oleophilic (or hydrophobic, i.e. ink-accepting, water-repelling) areas as well as hydrophilic (or oleophobic, i.e. water-accepting, ink-repelling) areas. In so-called “driographic” printing, the lithographic image consists of ink-accepting and ink-abhesive (ink-repelling) areas and during driographic printing, only ink is supplied to the master.

Printing masters are generally obtained by the so-called computer-to-film (CtF) method wherein various pre-press steps such as typeface selection, scanning, color separation, screening, trapping, layout and imposition are accomplished digitally and each color selection is transferred to graphic arts film using an image-setter. After processing, the film can be used as a mask for the exposure of an imaging material called plate precursor and after plate processing, a printing plate is obtained which can be used as a master. Since about 1995, the so-called ‘computer-to-plate’ (CtP) method has gained a lot of interest. This method, also called ‘direct-to-plate’, bypasses the creation of film because the digital document is transferred directly to a plate precursor by means of a so-called plate-setter.

Especially thermal plates, which are sensitive to heat or infrared light, are widely used in computer-to-plate methods because of their daylight stability. Such thermal materials may be exposed directly to heat, e.g. by means of a thermal head, but preferably comprise a compound that converts absorbed light into heat and are therefore suitable for exposure by lasers, especially infrared laser diodes. The heat, which is generated on image-wise exposure, triggers a (physico-) chemical process, such as ablation, polymerization, insolubilization by cross-linking of a polymer, decomposition, or particle coagulation of a thermoplastic polymer latex, and after optional processing, a lithographic image is obtained.

EP-A 1 106 347 discloses a development-free, heat-sensitive lithographic printing plate precursor comprising on a support an image-forming layer and an overcoat layer. The image-forming layer comprises hydrophobic thermoplastic polymer particles dispersed in a hydrophilic binder polymer. The overcoat layer is soluble in water and comprises a water-soluble cyanine dye capable of absorbing infrared light and converting it into heat.

EP-A 816 070 discloses a heat-sensitive element comprising on a hydrophilic base an image-forming layer. That layer comprises hydrophobic thermoplastic particles and a compound capable of converting light into heat, wherein said compound being present in the image-forming layer or a layer adjacent thereto. The image-forming layer is further coated with a covering layer having a thickness between 0.1 and 3 μm.

U.S. Pat. No. 6,245,477 discloses a negative working heat-sensitive composition comprising a water-soluble binder and particles therein. Each of the particles comprises a pigment component and a thermoplastic resin component. The heat-sensitive composition is capable being provided on a substrate as a dry coating such that the aqueous developer solubility of the dry coating is decreased on heating.

EP-A 770 494 discloses a method wherein an imaging material is image-wise exposed. The imaging material comprises an image-recording layer of a hydrophilic binder, a compound capable of converting light to heat and hydrophobic thermoplastic polymer particles. The exposure induces coalescence of the polymer particles and converts the exposed areas into a hydrophobic phase which defines the printing areas of the printing master. The press run can be started immediately after exposure without any additional treatment because the layer is developed by interaction with the fountain and ink that are supplied to the cylinder during the press run. During the first runs of the press, the non-exposed areas are removed from the support and thereby define the non-printing areas of the plate.

A problem associated with the prior art thermal plate materials which are based on heat-induced coagulation of thermoplastic polymer particles, is the lack of a sufficient contrast in the image generated on the plate after developing. Therefore it is difficult for the end-user to identify the plates (e.g. which plates belongs to what set of plates). It is also quite difficult to analyse the quality of image formed on the plate and to make a decision on which plate has to be corrected or even which plate-has to be remade. As a result, for such plates a test printing step is required to evaluate which plates are appropriate to start the printing process.

EP-A 1 342 568 discloses a method of making a lithographic printing plate wherein an imaging material comprising an image-recording layer of a hydrophilic binder, a compound capable of converting light to heat and hydrophobic thermoplastic polymer particles, is image-wise exposed, thereby inducing coalescence of the polymer particles. The image-wise exposed material is processed by applying a gum solution to the image-recording layer, thereby removing non-exposed areas of the coating from the support. In order to provide a visible image after processing, colorants are added to the image-recording layer.

### SUMMARY OF THE INVENTION

The inventors of the prior art application EP-A 1 342 568 have established that the addition of these colorants to the image recording layer interferes with coalescence of the polymer particles in the exposed areas, inducing a lower sensitivity. Another problem related to these colorants is staining, i.e. ink-acceptance at the non-image areas during the printing process. This problem is related to an adsorption of colorants, remaining on the hydrophilic surface of the substrate in the non-exposed areas after processing, inducing a decreased hydrophilicity and/or increased hydrophobicity.

It is an object of the present invention to provide a heat-sensitive imaging element showing an improved image-contrast and a reduced staining after processing. This object is realized by the precursor as defined in claim 1, having the characteristic feature that the precursor comprises an infrared absorbing compound present in at least one of an image recording layer or contrast layer, and that a contrast layer, i.e. a separate layer on the image recording layer, further comprises a colorant.

Other specific embodiments of the invention are defined in the dependent claims.

### DETAILED DESCRIPTION OF THE INVENTION

In accordance with the present invention, there is provided a heat-sensitive lithographic printing plate precursor comprising in the order given (i) a lithographic base having a hydrophilic surface, (ii) an image recording layer comprising hydrophobic thermoplastic polymer particles and (iii) a contrast layer, said precursor comprising an infrared absorbing compound present in at least one of said image recording layer or contrast layer, wherein said contrast layer further comprises a colorant capable of providing a visible image after exposure and development of the precursor and wherein said image recording layer is substantially free of said colorant.

“Substantially free of” means that no colorant is added to the coating solution or dispersion in the preparation of the image recording layer, but that it is not excluded that traces of colorant are present in the image recording layer, e.g. due to a partially mixing of the image recording layer with the contrast layer or due to a partially diffusion of the colorant from the contrast layer into the image recording layer. Therefor, one or more intermediate layers may be present between the contrast layer and the image recording layer. The contrast layer may also directly be in contact with the image recording layer.

Said colorant can be a dye or a pigment. Said dye or pigment can be used as a colorant when the layer, comprising the dye or pigment, is colored for the human eye.

In a preferred embodiment of the present invention, the colorant is a pigment. Various types of pigments can be used such as organic pigments, inorganic pigments, carbon black, metallic powder pigments and fluorescent pigments. Organic pigments are preferred.

Specific examples of organic pigments include quinacridone pigments, quinacridonequinone pigments, dioxazine pigments, phthalocyanine pigments, anthrapyrimidine pigments, anthanthrone pigments, indanthrone pigments, flavanthrone pigments, perylene pigments, diketopyrrolopyrrole pigments, perinone pigments, quinophthalone pigments, anthraquinone pigments, thioindigo pigments, benzimidazolone pigments, isoindolinone pigments, azomethine pigments, and azo pigments.

Specific examples of pigments usable as colorant are the following (herein is C.I. an abbreviation for Color Index; under a Blue colored pigment is understood a pigment that appears blue for the human eye; the other colored pigments have to be understood in an analogue way):
Blue colored pigments which include C.I. Pigment Blue 1, C.I. Pigment Blue 2, C.I. Pigment Blue 3, C.I. Pigment Blue 15:3, C.I. Pigment Blue 15:4, C.I. Pigment Blue 15:34, C.I. Pigment Blue 16, C.I. Pigment Blue 22, C.I. Pigment Blue 60 and the like; and C.I. Vat Blue 4, C.I. Vat Blue 60 and the like;
Red colored pigments which include C.I. Pigment Red 5, C.I. Pigment Red 7, C.I. Pigment Red 12, C.I. Pigment Red 48 (Ca), C.I. Pigment Red 48 (Mn), C.I. Pigment Red 57 (Ca), C.I. Pigment Red 57:1, C.I. Pigment Red 112, C.I. Pigment Red 122, C.I. Pigment Red 123, C.I. Pigment Red 168, C.I. Pigment Red 184, C.I. Pigment Red 202, and C.I. Pigment Red 209;
Yellow colored pigments which include C.I. Pigment Yellow 1, C.I. Pigment Yellow 2, C.I. Pigment Yellow 3, C.I. Pigment Yellow 12, C.I. Pigment Yellow 13, C.I. Pigment Yellow 14C, C.I. Pigment Yellow 16, C.I. Pigment Yellow 17, C.I. Pigment Yellow 73, C.I. Pigment Yellow 74, C.I. Pigment Yellow 75, C.I. Pigment Yellow 83, C.I. Pigment Yellow 93, C.I. Pigment Yellow 95, C.I. Pigment Yellow 97, C.I. Pigment Yellow 98, C.I. Pigment Yellow 109, C.I. Pigment Yellow 110, C.I. Pigment Yellow 114, C.I. Pigment Yellow 128, C.I. Pigment Yellow 129, C.I. Pigment Yellow 138, C.I. Pigment Yellow 150, C.I. Pigment Yellow 151, C.I. Pigment Yellow 154, C.I. Pigment Yellow 155, C.I. Pigment Yellow 180, and C.I. Pigment Yellow 185;
Orange colored pigments include C.I. Pigment Orange 36, C.I. Pigment Orange 43, and a mixture of these pigments. Green colored pigments include C.I. Pigment Green 7, C.I. Pigment Green 36, and a mixture of these pigments;
Black colored pigments include: those manufactured by Mitsubishi Chemical Corporation, for example, No. 2300, No. 900, MCF 88, No. 33, No. 40, No. 45, No. 52, MA 7, MA 8, MA 100, and No. 2200 B; those manufactured by Columbian Carbon Co., Ltd., for example, Raven 5750, Raven 5250, Raven 5000, Raven 3500, Raven 1255, and Raven 700; those manufactured by Cabot Corporation, for example, Regal 400 R, Regal 330 R, Regal 660 R, Mogul L, Monarch 700, Monarch 800, Monarch 880, Monarch 900, Monarch 1000, Monarch 1100, Monarch 1300, and Monarch 1400; and those manufactured by Degussa, for example, Color Black FW 1, Color Black FW 2, Color Black FW 2 V, Color Black FW 18, Color Black FW 200, Color Black S 150, Color Black S 160, Color Black S 170, Printex 35, Printex U, Printex V, Printex 140 U, Special Black 6, Special Black 5, Special Black 4A, and Special Black 4.

Other types of pigments such as brown pigments, violet pigments, fluorescent pigments and metallic powder pigments can also be used as colorant. The pigments may be used alone or as a mixture of two or more pigments as colorant in the contrast layer.

According to the present invention, blue colored pigments, including cyan pigments, are preferred and blue colored phthalocyanine or phthalocyanine-containing pigments are most preferred.

The pigments may be used with or without being subjected to surface treatment of the pigment particles. In accordance to another preferred embodiment of the present invention, the pigments are subjected to surface treatment.

Methods for surface treatment include methods of applying a surface coat of resin, methods of applying surfactant, and methods of bonding a reactive material (for example, a silane coupling agent, an epoxy compound, polyisocyanate, or the like) to the surface of the pigment. Suitable examples of pigments with surface treatment are the modified pigments described in WO 02/04210. Specifically the blue colored modified pigments described in WO 02/04210 are highly preferred as colorant in the present invention.

In accordance to the present invention the pigments have a particle size which is preferably less than 10 μm, more preferably less than 5 μm and especially preferably less than 3 μm. The method for dispersing the pigments may be any known dispersion method which is used for the production of ink or toner or the like. Dispersing machines include an ultrasonic disperser, a sand mill, an attritor, a pearl mill, a super mill, a ball mill, an impeller, a dispenser, a KD mill, a colloid mill, a dynatron, a three-roll mill and a press kneader. Details thereof are described in “Latest Pigment Applied Technology” (CMC Publications, published in 1986).

According to a preferred embodiment of the present invention, a pigment dispersion is used in the preparation of the coating solution for coating the contrast layer. The pigment dispersion comprises preferably one or more dispersing agent. The dispersing agent stabilises the dispersed pigment particles and prevents coalescing of the particles. Therefor, suitable dispersing agents are preferably surfactants and/or polymers which are soluble in the dispersion liquid.

In accordance with the present invention, the dispersion liquid for the pigment dispersion is preferably an aqueous liquid. Such aqueous liquids include water and mixtures of water with water-miscible organic solvents such as alcohols e.g. methanol, ethanol, 2-propanol, butanol, iso-amyl alcohol, octanol, cetyl alcohol etc; glycols e.g. ethylene glycol; glycerine; N-methylpyrrolidone; methoxypropanol; and ketones e.g. 2-propanone and 2-butanone etc.

Surfactants, suitable as dispersing agent in aqueous liquids, are by preference anionic or non-ionic surfactants or a combination of anionic and non-ionic surfactants. The anionic surfactant comprises preferably a sulfonate, a carboxylate or a phospate ionic group. The non-ionic surfactant comprises preferably ethylene-oxide groups and/or propylene-oxide groups.

Examples of non-ionic and anionic surfactants, suitable as dispersing agents, are:
GAFAC™ RM710, an alkylphenoxy polyethoxy dihydrogen-phosphate from GENERAL ANILINE;
ANTAROX™ B290, a condensation product of caster oil with a ca. 40 unit long polyethyleneoxide chain from GENERAL ANILINE;
ANTAROX™ C0880, nonylphenoxy polyethoxy ethanol with about 30 polyethoxy units from GENERAL ANILINE;
ULTRAVON™ W, a sodium salt of an alkaryl sulfonate from CIBA-GEIGY;
MERSOLAT™ H, a sodium salt of an alkyl sulfonate from BAYER;
MARLON™ A-396, a sodium salt of dodecylbenzene sulfonate from HÜLS;
AEROSOL™ OT, a sodium salt of the bis-(2′-ethylhexyl)ester of sulfosuccinic acid from AMERICAN CYANAMID;
HOSTAPON™ T, a sodium β-(methyl-oleyl-amino)ethylsulfonate from HOECHST;
HOSTAPAL™ BV, a sodium 2,4,6-tributylphenoxy polyethoxy sulfonate from HOECHST;
NEFAL™ BX, a sodium salt of 4,7-dibutyl-2-sulfonaphthalene from BASF;
AKYPO™ OP-80, a sodium salt of octylphenoxy-polyethoxy-acetic acid from CHEMY;
TERGITOL™ 4, a sodium salt of 1-isobutyl-4-ethyl-octyl-sulfate from UNION CARBIDE;
ERKANTOL™ BX, a sodium salt of 4,7-bis(isobutyl)-2-naphthalenesulfonic acid from BAYER;
ALKANOL™ XC, a sodium salt of tris(isopropyl)naphthalene-sulfonic acid from DU PONT.

Specific examples of polymers, suitable as dispersing agent in aqueous liquids, are polymers comprising ionic or ionisable groups or containing polyethyleneoxide groups. Examples of ionic or ionisable groups are acid groups or salts thereof such as carboxylic acid, sulphonic acid, phosphoric acid or phosphonic acid. The acid groups in the polymer may be neutralized with an organic amine (e.g. ammonia, triethylamine, tributylamine, dimethylethanolamine, diisopropanolamine, morpholine, diethanolamine or triethanolamine) or an alkali metal (e.g. lithium, sodium or potassium). The polymer may be composed of a monomer comprising an anionic group. The polymer may also be composed of two or more different types of monomers comprising anionic and/or non-ionic groups. Specific examples of monomers comprising anionic groups are (meth)acrylic acid, crotonic acid, (meth)acrylic acid, propyl(meth)acrylic acid, isopropyl(meth)acrylic acid, itaconic acid, fumaric acid, sulfoethyl(meth)acrylate, butyl(meth)acrylamidesulfonic acid and phosphoethyl(meth)acrylate, polystyrene sulphonic acid and salts thereof, such as sodium, potasium or ammonium salts. In general, the weight-average molecular weight of the polymer is preferably in the range of about 1,000 to 3,000,000.

A dispersing agent may be omitted in the preparation of dispersions of so-called self-dispersing pigments. Specific examples of self-dispersing pigments are pigments with are subjected to a surface treatment in such a way the pigment surface is compatible with the dispersing liquid. Typical examples of self-dispersing pigments in an aqueous medium are pigments which have ionic or ionisable groups or polyethyleneoxide chains coupled to the particle-surface. Examples of ionic or ionisable groups are acid groups or salts thereof such as carboxylic acid group, sulphonic acid, phosphoric acid or phosphonic acid and alkali metal salts of these acids. Suitable examples of self-dispersing pigments are described in WO 02/04210 and these are preferred in the present invention. The blue colored self-dispersing pigments in WO 02/04210 are more preferred and specially the phthalocyanine containing blue colored self-dispersing pigments in WO 02/04210 are most preferred in the present invention.

In order to prevent adsorption of the colorant on the hydrophilic surface of the plate in the non-exposed areas, the pigment particles are preferably not positively charged, i.e. the number of positive groups, present on the surface of the particles, is inferior to the number of negative groups. By preference, the presence of positive groups is kept as low as possible. Therefor, it is preferred not to use cationic surfactants or polymers bearing cationic groups in the preparation of the pigment dispersion or in the preparation of the coating solution of the contrast layer.

Typically, the amount of pigment in the contrast layer may be in the range of about 0.005 g/m² to 2 g/m², preferably about 0.007 g/m² to 0.5 g/m², more preferably about 0.01 g/m² to 0.2 g/m², most preferably about 0.01 g/m² to 0.1 g/m².

In accordance with the present invention, also a dye can be used as colorant in the contrast layer of the present invention. Any known dyes, such as commercially available dyes or dyes described in, for example, “Dye Handbook” (edited by the Organic Synthetic Chemistry Association, published in 1970) which are colored for the human eye, can be used as colorant in the contrast layer. Specific examples thereof include azo dyes, metal complex salt azo dyes, pyrazolone azo dyes, anthraquinone dyes, phthalacyanine dyes, carbionium dyes, quinonimine dyes, methine dyes, and the like. Phthalocyanine dyes are preferrred. Suitable dyes are salt-forming organic dyes and may be selected from oil-soluble dyes and basic dyes. Specific examples thereof are (herein is CI an abbreviation for Color Index): Oil Yellow 101, Oil Yellow 103, Oil Pink 312, Oil Green BG, Oil Bue GOS, Oil Blue 603, Oil Black BY, Oil Black BS, Oil Black T-505, Victoria Pure Blue, Crystal Violet (CI42555), Methyl Violet (CI42535), Ethyl Violet, Rhodamine B (CI415170B), Malachite Green (CI42000), Methylene Blue (CI52015). Also, the dyes dislosed in GB 2 192 729 may be used as colorant.

In order to prevent adsorption of the colorant on the hydrophilic surface of the plate in the non-exposed areas, the dye has preferably no net positive charge. Dyes with an anionic (or acidic) group are preferred as colorant.

Typically, the amount of dye in the contrast layer may be in the range of about 0.005 g/m² to 2 g/m², preferably about 0.007 g/m² to 0.5 g/m², more preferably about 0.01 g/m² to 0.2 g/m², most preferably about 0.01 g/m² to 0.1 g/m².

As already indicated above staining can be minimized by using anionic or non-ionic surfactants and/or hydrophilic polymers bearing anionic (or acidic) groups or non-ionic hydrophilic groups as dispersing agents in the preparation of the pigment dispersion or as binder in the preparation of the coating solution of the contrast layer. In order to minimize partial mixing of the contrast layer with the image recording layer, it is advantageous to reduce the pH of the coating solution of the contrast layer. The coating solution of the contrast layer has preferably a pH-value lower than 4, more preferably lower than 3, most preferred lower than 2.5.

The contrast of the image formed after processing depends on the amount and the extinction coefficient of the colorant remaining in the exposed areas of the plate. The contrast of the image formed after processing is defined as the difference between the optical density in the exposed area to the optical density in the non-exposed area. The optical density values, reported hereinafter, are measured in reflectance by an optical densitometer, which is equipped with several filters (e.g. cyan, magenta, yellow). The optical densities are measured with a filter in correspondance with the color of the colorant, e.g. a cyan filter is used for measuring the optical density of a blue colored image layer.

In order to obtain a sufficient contrast for the present invention, the value of this difference in optical density is preferably at least 0.3, more preferably at least 0.4, and most preferably at least 0.5. There is no specific upper limit for the contrast value, but typically the contrast is not higher than 3.0 or even not higher than 2.0.

In order to obtain a good visual contrast for a human observer the type of color of the colorant may also be important. Preferred colors for the colorant are cyan or blue colors, i.e. under blue color we understand a color that appears blue for the human eye.

Low staining is characterized by a small difference between the optical density in the non-exposed areas and the optical density of the hydrophilic surface on the lithographic base. This difference is preferably less than 0.25, more preferably less than 0.20, most preferably less than 0.15. In order to simulate the self-life of the material, the printing plate precursor is aged for 7 days at 35° C. and 80% relative humidity. The measurement of the optical density in the non-image areas after this ageing is a more critical test for staining than when the material is only aged for 7 days at room temperature.

It is also an aspect of the present invention that said contrast layer preferably further comprises a hydrophilic polymeric binder or a surfactant.

Specific examples of hydrophilic polymers which may be added to the contrast layer are gum arabic, alginic acid, pullulan, cellulose derivatives such as carboxymethylcellulose, carboxyethylcellulose or methylcellulose, (cyclo)dextrin, poly(vinyl alcohol), polystyrene sulphonic acid and salts thereof such as sodium, potassium or ammonium salt, poly(vinyl pyrrolidone), polysaccharide, homo- and copolymers of acrylic acid, methacrylic acid or acrylamide, a copolymer of vinyl methyl ether and maleic anhydride, a copolymer of vinyl acetate and maleic anhydride or a copolymer of styrene and maleic anhydride. Highly preferred polymers are homo- or copolymers of monomers containing carboxylic, sulfonic-or phosphonic groups or the salts thereof, e.g. (meth)acrylic acid, vinyl acetate, styrene sulfonic acid, vinyl sulfonic acid, vinyl phosphonic acid or acrylamidopropane sulfonic acid.

In another preferred embodiment, the contrast layer comprises an ionic surfactant or non-ionic surfactant, more preferably an anionic surfactant. Specific examples of anionic surfactants which may be added to the contrast layer include aliphates, abietates, hydroxyalkanesulfonates, alkanesulfonates, dialkylsulfosuccinates, straight-chain alkylbenzenesulfonates, branched alkylbenzenesulfonates, alkylnaphthalenesulfonates, alkylphenoxypolyoxyethylenepropylsulfonates, salts of polyoxyethylene alkylsulfophenyl ethers, sodium N-methyl-N-oleyltaurates, monoamide disodium N-alkylsulfosuccinates, petroleum sulfonates, sulfated castor oil, sulfated tallow oil, salts of sulfuric esters of aliphatic alkylesters, salts of alkylsulfuric esters, sulfuric esters of polyoxyethylenealkylethers, salts of sulfuric esters of aliphatic monoglycerides, salts of sulfuric esters of polyoxyethylenealkylphenylethers, salts of sulfuric esters of polyoxyethylenestyrylphenylethers, salts of alkylphosphoric esters, salts of phosphoric esters of polyox-yethylenealkylethers, salts of phosphoric esters of polyoxyethylenealkylphenylethers, partially saponified compounds of styrene-maleic anhydride copolymers, partially saponified compounds of olefin-maleic anhydride copolymers, and naphthalenesulfonateformalin condensates. Particularly preferred among these anionic surfactants are dialkylsulfosuccinates, salts of alkylsulfuric esters and alkylnaphthalenesulfonates. Other examples of suitable anionic surfactants include sodium dodecylphenoxybenzene disulfonate, the sodium salt of alkylated naphthalenesulfonate, disodium methylene-dinaphtalene-disulfonate, sodium dodecyl-benzenesulfonate, sulfonated alkyl-diphenyloxide, ammonium or potassium perfluoroalkylsulfonate and sodium dioctyl-sulfosuccinate. Suitable examples of the nonionic surfactants include polyoxyethylene alkyl ethers, polyoxyethylene alkyl phenyl ethers, polyoxyethylene polystyryl phenyl ethers, polyoxyethylene polyoxypropylene alkyl ethers, polyoxyethylene polyoxypropylene block polymers, partial esters of glycerinaliphatic acids, partial esters of sorbitanaliphatic acid, partial esters of pentaerythritolaliphatic acid, propyleneglycolmonoaliphatic esters, partial esters of sucrosealiphatic acids, partial esters of polyoxyethylenesorbitanaliphatic acid, partial esters of polyoxyethylenesorbitolaliphatic acids, polyethyleneglycolaliphatic esters, partial esters of poly-glycerinaliphatic acids, polyoxyethylenated castor oils, partial esters of polyoxyethyleneglycerinaliphatic acids, aliphatic diethanolamides, N,N-bis-2-hydroxyalkylamines, polyoxyethylene alkylamines, triethanolaminealiphatic esters, and trialkylamine oxides. Particularly preferred among these nonionic surfactants are polyoxyethylene alkylphenyl ethers and poloxyethylene-polyoxypropylene block polymers. Further, fluoronic and siliconic anionic and nonionic surfactants may be similarly used.

Two or more of the above surfactants may be used in combination. For example, a combination of two or more different anionic surfactants or a combination of an anionic surfactant and a nonionic surfactant may be preferred. Mixtures of surfactants and hydrophilic polymers may also be used.

According to a preferred embodiment of the present invention, said contrast layer further comprises a mineral acid, an organic acid or an inorganic salt. Examples of the mineral acids include nitric acid, sulfuric acid, phosphoric acid and metaphosphoric acid. Examples of the organic acids include carboxylic acids, sulfonic acids, phosphonic acids or salts thereof, e.g. succinates, phosphates, phosphonates, sulfates and sulfonates. Specific examples of the organic acid include citric acid, acetic acid, oxalic acid, malonic acid, p-toluenesulfonic acid, tartaric acid, malic acid, lactic acid, levulinic acid, phytic acid and organic phosphonic acid. Examples of the inorganic salt include magnesium nitrate, monobasic sodium phosphate, dibasic sodium phosphate, nickel sulfate, sodium hexametaphosphate and sodium tripolyphosphate. Other inorganic salts can be used as corrosion inhibiting agents, e.g. magnesium sulfate or zinc nitrate. The mineral acid, organic acid or inorganic salt may be used singly or in combination with one or more thereof.

Besides the foregoing components, the contrast layer may further comprise a wetting agent such as ethylene glycol, propylene glycol, triethylene glycol, butylene glycol, hexylene glycol, diethylene glycol, dipropylene glycol, glycerin, trimethylol propane and diglycerin. The wetting agent may be used singly or in combination with one or more thereof. In general, the foregoing wetting agent is preferably used in an amount of from 1 to 25 wt. % of the coating solution of the contrast layer.

Further, a chelate compound may be present in the contrast coating solution. Calcium ion and other impurities contained in the diluting water can have adverse effects on printing and thus cause the contamination of printed matter. This problem can be eliminated by adding a chelate compound to the diluting water. Preferred examples of such a chelate compound include organic phosphonic acids or phosphonoalkanetricarboxylic acids. Specific examples are potassium or sodium salts of ethylenediaminetetraacetic acid, diethylenetriaminepentaacetic acid, triethylenetetraminehexaacetic acid, hydroxyethylethylenediaminetriacetic acid, nitrilotriacetic acid, 1-hydroxyethane-1,1-diphosphonic acid and aminotri(methylenephosphonic acid). Besides these sodium or potassium salts of these chelating agents, organic amine salts are useful. The preferred amount of such a chelating agent to be added is from 0.001 to 1.0 wt. % relative to the contrast coating solution.

Further, an antiseptic and an anti-foaming agent may be present in the contrast coating solution. Examples of such an antiseptic include phenol, derivatives thereof, formalin, imidazole derivatives, sodium dehydroacetate, 4-isothiazoline-3-one derivatives, benzoisothiazoline-3-one, benztriazole derivatives, amidineguanidine derivatives, quaternary ammonium salts, pyridine derivatives, quinoline derivatives, guanidine derivatives, diazine, triazole derivatives, oxazole and oxazine derivatives. The preferred amount of such an antiseptic to be added is such that it can exert a stable effect on bacteria, fungi, yeast or the like. Though depending on the kind of bacteria, fungi and yeast, it is preferably from 0.01 to 4 wt. % relative to the contrast coating solution. Further, preferably, two or more antiseptics may be used in combination to exert an aseptic effect on various fungi and bacteria. The anti-foaming agent is preferably silicone anti-foaming agents. Among these anti-foaming agents, either an emulsion dispersion type or solubilized type anti-foaming agent may be used. The proper amount of such an anti-foaming agent to be added is from 0:001 to 1.0 wt. % relative to the contrast coating solution.

Besides the foregoing components, an ink receptivity agent may be present in the contrast coating solution if desired. Examples of such an ink receptivity agent include turpentine oil, xylene, toluene, low heptane, solvent naphtha, kerosine, mineral spirit, hydrocarbons such as petroleum fraction having a boiling point of about 120° C. to about 250° C., diester phthalates (e.g., dibutyl phthalate, diheptyl phthalate, di-n-octyl phthalate, di(2-ethylhexyl) phthalate, dinonyl phthalate, didecyl phthalate, dilauryl phthalate, butylbenzyl phthalate), aliphatic dibasic esters (e.g., dioctyl adipate, butylglycol adipate, dioctyl azelate, dibutyl sebacate, di(2-ethylhexyl) sebacate dioctyl sebacate), epoxidated triglycerides (e.g., epoxy soyabean oil), ester phosphates (e.g., tricresyl phosphate, trioctyl phosphate, trischloroethyl phosphate) and plasticizers having a solidification point of 15° C. or less and a boiling point of 300° C. or more at one atmospheric pressure such as esters of benzoates (e.g., benzyl benzoate). Examples of other solvents which can be used in combination with these solvents include ketones (e.g., cyclohexanone), halogenated hydrocarbons (e.g., ethylene dichloride), ethylene glycol ethers (e.g., ethylene glycol monomethyl ether, ethylene glycol monophenyl ether, ethylene glycol monobutyl ether), aliphatic acids (e.g., caproic acid, enathic acid, caprylic acid, pelargonic acid, capric acid, undecylic acid, lauric acid, tridecylic acid, myristic acid, pentadecylic acid, palmitic acid, heptadecylic acid, stearic acid, nonadecanic acid, arachic acid, behenic acid, lignoceric acid, cerotic acid, heptacosanoic acid, montanic acid, melissic acid, lacceric acid, isovaleric acid) and unsaturated aliphatic acids (e.g., acrylic acid, crotonic acid, isocrotonic acid, undecyclic acid, oleic acid, elaidic acid, cetoleic acid, erucic acid, butecidic acid, sorbic acid, linoleic acid, linolenic acid, arachidonic acid, propiolic acid, stearolic acid, clupanodonic acid, tariric acid, licanic acid). Preferably, it is an aliphatic acid which is liquid at a temperature of 50° C., more preferably has from 5 to 25 carbon atoms, most preferably has from 8 to 21 carbon atoms. The ink receptivity agent may be used singly or in combination with one or more thereof. The ink receptivity agent is preferably used in an amount of from 0.01 to 10 wt. %, more preferably from 0.05 to 5 wt. %. The foregoing ink receptivity agent may be present as an oil-in-water emulsion or may be solubilized with the aid of a solubilizing agent.

The viscosity of the contrast layer coating solution can be adjusted to a value of e.g. between 1.7 and 5 cP, by adding viscosity increasing compounds, such as poly(ethylene oxide), e.g. having a molecular weight between 10 and 10 g/mol. Such compounds can be present in a concentration of 0.01 to 10 g/l.

The lithographic printing plate precursor used in the method of the present invention is negative-working and develops a lithographic image consisting of hydrophobic and hydrophilic areas at the exposed and non-exposed areas respectively. The hydrophilic areas are defined by the support which has a hydrophilic surface or is provided with a hydrophilic layer. The support may be a sheet-like material such as a plate or it may be a cylindrical element such as a sleeve which can be slid around a print cylinder of a printing press. Preferably, the support is a metal support such as aluminum or stainless steel.

A particularly preferred lithographic support is an electrochemically grained and anodized aluminum support. The anodized aluminum support may be treated to improve the hydrophilic properties of its surface. For example, the aluminum support may be silicated by treating its surface with a sodium silicate solution at elevated temperature, e.g. 95° C. Alternatively, a phosphate treatment may be applied which involves treating the aluminum oxide surface with a phosphate solution that may further contain an inorganic fluoride. Further, the aluminum oxide surface may be rinsed with a citric acid or citrate solution. This treatment may be carried out at room temperature or may be carried out at a slightly elevated temperature of about 30 to 50° C. A further interesting treatment involves rinsing the aluminum oxide surface with a bicarbonate solution. Still further, the aluminum oxide surface may be treated with polyvinylphosphonic acid, polyvinylmethylphosphonic acid, phosphoric acid esters of polyvinyl alcohol, polyvinylsulfonic acid, polyvinylbenzenesulfonic acid, sulfuric acid esters of polyvinyl alcohol, and acetals of polyvinyl alcohols formed by reaction with a sulfonated aliphatic aldehyde It is further evident that one or more of these post treatments may be carried out alone or in combination. More detailed descriptions of these treatments are given in GB-A-1 084 070, DE-A-4 423 140, DE-A-4 417 907, EP-A-659 909, EP-A-537 633, DE-A-4 001 466, EP-A-292 801, EP-A-291 760 and U.S. Pat. No. 4 458 005.

According to another embodiment, the support can also be a flexible support, which may be provided with a hydrophilic layer, hereinafter called ‘base layer’. The flexible support is e.g. paper, plastic film or aluminum. Preferred examples of plastic film are polyethylene terephthalate film, polyethylene naphthalate film, cellulose acetate film, polystyrene film, polycarbonate film, etc. The plastic film support may be opaque or transparent.

The base layer is preferably a cross-linked hydrophilic layer obtained from a hydrophilic binder cross-linked with a hardening agent such as formaldehyde, glyoxal, polyisocyanate or a hydrolyzed tetra-alkylorthosilicate. The latter is particularly preferred. The thickness of the hydrophilic base layer may vary in the range of 0.2 to 25 μm and is preferably 1 to 10 μm. More details of preferred embodiments of the base layer can be found in e.g. EP-A 1 025 992.

The image recording layer contains hydrophobic thermoplastic polymer particles. Specific examples of suitable hydrophobic polymers are e.g. polyethylene, poly(vinyl chloride), poly(methyl (meth)acrylate), poly(ethyl(meth)acrylate), poly(vinylidene chloride), poly(meth)acrylonitrile, poly(vinyl carbazole), polystyrene or copolymers thereof. Polystyrene and poly(meth)acrylonitrile or their derivatives are highly preferred embodiments. According to such preferred embodiments, the thermoplastic polymer comprises at least 50 wt. % of polystyrene, and more preferably at least 60 wt. % of polystyrene. In order to obtain sufficient resistivity towards organic chemicals, such as the hydrocarbons used in plate cleaners, the thermoplastic polymer preferably comprises at least 5 wt. %, more preferably at least 30 wt. % of nitrogen containing monomeric units or of units which correspond to monomers that are characterized by a solubility parameter larger than 20, such as (meth)acrylonitrile. Suitable examples of such nitrogen containing monomeric units are disclosed in EP-A 1 219 416.

According to a high preferred embodiment, the thermoplastic polymer is a copolymer consisting of styrene and acrylonitrile units in a weight ratio between 1:1 and 5:1 (styrene:acrylonitrile), e.g. in a 2:1 ratio.

The weight average molecular weight of the thermoplastic polymer particles may range from 5,000 to 1,000,000 g/mol. The hydrophobic particles preferably have a number average particle diameter below 200 nm, more preferably between 10 and 100 nm. The amount of hydrophobic thermoplastic polymer particles contained in the image-recording layer is preferably between 20 wt. % and 65 wt. % and more preferably between 25 wt. % and 55 wt. % and most preferably between 30 wt. % and 45 wt. %.

The hydrophobic thermoplastic polymer particles are present as a dispersion in an aqueous coating liquid of the image-recording layer and may be prepared by the methods disclosed in U.S. Pat. No. 3,476,937. Another method especially suitable for preparing an aqueous dispersion of the thermoplastic polymer particles comprises:
dissolving the hydrophobic thermoplastic polymer in an organic water immiscible solvent,
dispersing the thus obtained solution in water or in an aqueous medium and
removing the organic solvent by evaporation.

The image recording layer preferably comprises a hydrophilic binder, e.g. homopolymers and copolymers of vinyl alcohol, acrylamide, methylol acrylamide, methylol methacrylamide, acrylic acid, methacrylic acid, hydroxyethyl acrylate, hydroxyethyl methacrylate or maleic anhydride/vinylmethylether copolymers. The hydrophilicity of the (co)polymer or (co)polymer mixture used is preferably the same as or higher than the hydrophilicity of polyvinyl acetate hydrolyzed to at least an extent of 60 percent by weight, preferably 80 percent by weight.

The heat sensitive lithographic printing plate precursor further comprises an infrared absorbing compound. This compound is preferably a dye or pigment having an absorption maximum in the infrared wavelength range and is capable of converting infrared light into heat. Infrared absorbing dyes are more preferred. Particularly usefull and specially preferred infrared absorbing dyes are IR-cyanine dyes, IR-merocyanine dyes, IR-methine dyes, IR-naphthoquinone dyes or IR-squarylium dyes. Highly preferred IR-cyanine dyes are the anionic IR-cyanine dyes, specially more preferred those with two sulphonic acids groups. Still more preferably are IR-cyanine dyes with two indolenine and at least two sulphonic acids groups.

The infrared absorbing compound is present in at least one of the image recording layer and the contrast layer or in both layers. The concentration of the infrared absorbing compound in the heat sensitive coating is preferably between 0.25 and 20% by weight, more preferably between 0.5 and 10% by weight relative to the coating as a whole.

According to most preferred embodiment of the present invention, the precursor comprises the combination of an image recording layer, wherein an infrared absorbing dye is present as infrared absorbing compound, and a contrast layer, wherein a pigment is present as colorant. The combination of an image recording layer, comprising an anionic IR-cyanine dye, and a contrast layer, comprising a self-dispersing or a surface-treated pigment, is still more preferred according to the present invention.

The image recording layer may also contain other ingredients such as additional binders, development inhibitors or accelerators.

The printing plate precursors used in the present invention are exposed to infrared light, e.g. by means of an infrared laser. Preferably, a laser emitting near infrared light having a wavelength in the range from about 700 to about 1500 nm is used, e.g. a semiconductor laser diode, a Nd:YAG or a Nd:YLF laser. The required laser power depends on the sensitivity of the image recording layer, the pixel dwell time of the laser beam, which is determined by the spot diameter (typical value of modern plate-setters at 1/e² of maximum intensity: 10-25 μm), the scan speed and the resolution of the exposure apparatus (i.e. the number of addressable pixels per unit of linear distance, often expressed in dots per inch or dpi; typical value: 1000-4000 dpi). Two types of laser-exposure apparatuses are commonly used: internal (ITD) and external drum (XTD) plate-setters. ITD plate-setters for thermal plates are typically characterized by a very high scan speed up to 500 m/sec and may require a laser power of several Watts. XTD plate-setters for thermal plates having a typical laser power from about 200 mW to about 1 W operate at a lower scan speed, e.g. from 0.1 to 10 m/sec.

Due to the heat generated during the exposure step, the hydrophobic thermoplastic polymer particles fuse or coagulate so as to form a hydrophobic phase which corresponds to the printing areas of the printing plate. Coagulation may result from heat-induced coalescence, softening or melting of the thermoplastic polymer particles. There is no specific upper limit to the coagulation temperature of the thermoplastic hydrophobic polymer particles, however the temperature should be sufficiently below the decomposition temperature of the polymer particles. Preferably the coagulation temperature is at least 10° C. below the temperature at which the decomposition of the polymer particles occurs. The coagulation temperature is preferably higher than 50° C., more preferably above 100° C.

In the development step, the non-exposed areas of the image-recording layer are removed by supplying a developing solution without essentially removing the exposed areas, i.e. without affecting the exposed areas to an extent that renders the ink-acceptance of the exposed areas inacceptable. The developing solution may be water, an aqueous solution or an aqueous alkaline solution. The development by supplying a developing solution may be combined with mechanical rubbing, e.g. by a rotating brush. The developing solution can be applied to the plate e.g. by rubbing in with an impregnated pad, by dipping, (spin-) coating, spraying, pouring-on, either by hand or in an automatic processing apparatus.

In another embodiment of the present invention, the image-wise exposed printing plate precursor may also be developed by mounting it on a print cylinder of a printing press and supplying an aqueous dampening liquid and/or ink to the surface of the plate while rotating the print cylinder. The end-user prefers to have sufficient latitude in plate handling (plate loading, mounting the plate on the press, etc.). Therefore it may be difficult for the end-user to avoid the plate surface gets in touch with ink (or with inked parts) before the plate is wetted by the dampening liquid. It is difficult to develop those parts contaminated by ink in the on-press processing step (herinafter also referred to as “clean-out”). This object is realised by further adding a hydrophilic polymer or surfactant to the contrast layer. In the on-press processing as described in the prior art documents, it is more difficult to obtain clean-out when ink is first added to the surface of the plate. In order to reduce the number of prints necessary to obtain clean-out, it is recommended for the end-user to add the dampening liquid before the ink. Surprisingly, due to the presence of the contrast layer, which further comprises a hydrophilic polymer or surfactant, it is no longer necessary for the end-user to add the dampening liquid first to the surface of the plate in order to reduce the number of prints necessary to obtain clean-out.

In still another embodiment of the present invention, the printing plate precursor may be mounted on a print cylinder of a printing press and subsequently image-wise exposed, optionally further developed on the printing press by supplying an aqueous dampening liquid and/or ink to the surface of the plate while is rotating the print cylinder.

### EXAMPLES

### Comparative Example 1

Preparation of the Lithographic Support

A 0.30 mm thick aluminum foil was degreased by immersing the foil in an aqueous solution containing 40 g/l of sodium hydroxide at 60° C. for 8 seconds and rinced with deminelarized water for 2 seconds. The foil was then electrochemically grained during 15 seconds using an alternating current in an aqueous solution containing 12 g/l of hydrochloric acid and 38 g/l of aluminum sulphate (18-hydrate) at a temperature of 33° C. and a current density of 90 A/dm². After rinsing with demineralized water for 2 seconds, the aluminum foil was then desmutted by etching with an aqueous solution containing 155 g/l of sulphuric acid at 70° C. for 4 seconds and rinsed with demineralized water at 25° C. for 2 seconds. The foil was subsequently subjected to anodic oxidiation during 13 seconds in an aqueous solution containing 155 g/l of sulphuric acid at a temperature of 45° C. and a current density of 30 A/dm², then washed with demineralized water for 2 seconds and post-treated for 10 seconds with a solution containing 4 g/l of polyvinylphosphonic acid at 40° C., rinsed with demineralized water at 20° C. during 2 seconds and dried.

The support thus obtained was characterized by a surface roughness Ra of 0.22 μm and an anodic weight of 4.0 g/m² of Al₂O₃.

Preparation of the Printing Plate Precursor

The lithographic aluminum support as prepared above was coated at a wet thickness of 30 g/m² with an aqueous coating solution. This aqueous coating solution was adjusted to a pH of 3.6 with ammonia and comprises the following ingredients of which the dry thicknesses in the image recording layer composition are also given below:
630 mg/m² of particles of a copolymer of styrene and acrylonitrile (weight ratio 60/40) having an average particle size of 65 nm and stabilized by an anionic wetting agent,
84 mg/m² of infrared absorbing Dye-1,
84 mg/m² of a high molecular weight polyacrylic acid GLASCOL E15, commercially available from ALLIED COLLOIDS, and
25 mg/m² of a Cu-phthalocyanine pigment CABOJET 250, commercially available from CABOT CORPORATION.

The infrared absorbing Dye-1 is

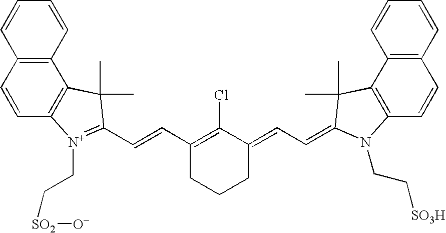

Ageing, Imaging, Processing and Optical Density Measurments

The printing plate precursors thus obtained were aged under two different conditions:
Condition 1: 7 days at at 35° C. and 80% relative humidity
Condition 2: 7 days at room temperature and ambient relative humidity (measured: 50%).

After ageing, the plates were then exposed with a CREO TRENDSETTER 3244 TH957, a plate-setter available from CREO, Burnaby, Canada, having the following specifications: power-output 40 Watt, wavelength 830 nm, drum diameter 286 mm, number of beams 192, spot size 10.6×2.5 micron (slowscan×fastscan), operating at 275 mJ/cm² on the plate and 150 rpm and with a resolution of 2400 dpi.

After imaging, the plates were developed in a HWP45-processor, available from AGFA-GEVAERT NV, filled with RC520, a baking gum solution, available from AGFA-GEVAERT NV.

After processing, the optical density of the exposed areas and non-exposed areas were measured with a GRETAG D19C-densitometer, using a cyan filter. These optical densities are measured in reflectance, after a cyan-filter with reference to an uncoated hydrophilic aluminum support.

The obtained results are summerized in Table 1.

### Invention Example 1

The preparation of printing plate precursor of Invention Example 1 is carried out in the same way as described for Comparative Example 1, with the exception that the 25 mg/m² of a Cu-phthalocyanine pigment CABOJET 250 was omitted in the image recording layer and that a separate contrast layer was coated onto the above described image recording layer. This contrast layer was coated at a wet thickness of 20 g/m² from an aqueous coating solution, adjusted to a pH of 2.5 with HCl and comprising as the sole ingredient CABOJET 250 at a dry thicknesses of 21 mg/m². After drying, the ageing, imaging, processing and optical density measurements are carried out in the same way as described in Comparative Example 1.

The obtained results are summerized in Table 1.

### Invention Example 2

The preparation of printing plate precursor of Invention Example 2 is carried out in the same way as described for Invention Example 1, with the exception that the 21 mg/m² of a Cu-phthalocyanine pigment CABOJET 250 was replaced by 21 mg/m² of another phthalocyanine pigment HELIOGEN BLAU D7565, available from BASF. (Heliogen Blau D7565 is a blue colored pigment, free of Cu and Cl.) After drying, the ageing, imaging, processing and optical density measurements are carried out in the same way as described in Comparative Example 1. The obtained results are summerized in Table 1.

### Invention Example 3

The preparation of printing plate precursor of Invention Example 3 is carried out in the same way as described for Invention Example 1, with the exception that the solution of contrast layer was adjusted to a pH of 3.6 with HCl and the amount of a Cu-phthalocyanine pigment CABOJET 250 was increased from 21 mg/m² to 42 mg/m². After drying, the ageing, imaging, processing and optical density measurements are carried out in the same way as described in Comparative Example 1.

The obtained results are summerized in Table 1.

### Invention Example 4

The preparation of printing plate precursor of Invention Example 4 is carried out in the same way as described for Invention Example 3, with the exception that the solution of contrast layer was adjusted to a pH of 2.5 with HCl. After drying, the ageing, imaging, processing and optical density measurements are carried out in the same way as described in Comparative Example 1.

The obtained results are summerized in Table 1.

### Invention Example 5

The preparation of printing plate precursor of Invention Example 5 is carried out in the same way as described for Invention Example 3, with the exception that the solution of contrast layer was adjusted to a pH of 2 with HCl. After drying, the ageing, imaging, processing and optical density measurements are carried out in the same way as described in Comparative Example 1.

The obtained results are summerized in Table 1.

### Invention Example 6

The preparation of printing plate precursor of Invention Example 6 is carried out in the same way as described for Invention Example 3, with the exception that the solution of contrast layer was adjusted to a pH of 1 with HCl. After drying, the ageing, imaging, processing and optical density measurements are carried out in the same way as described in Comparative Example 1.

The obtained results are summerized in Table 1.

### Invention Example 7

The preparation of printing plate precursor of Invention Example 7 is carried out in the same way as described for Invention Example 5, with the exception that a copolymer of acrylic acid and maleic acid “Aldrich 41,605-3”, commercially available from ALDRICH, was added to the solution of contrast layer, resulting after drying in a dry thickness of 63 mg/m². After drying, the ageing, imaging, processing and optical density measurements are carried out in the same way as described in Comparative Example 1.

The obtained results are summerized in Table 1.

### Invention Example 8

The preparation of printing plate precursor of Invention Example 8 is carried out in the same way as described for Invention Example 7, with the exception that a copolymer of acrylic acid and maleic acid “Aldrich 41,605-3”, commercially available from ALDRICH, was added to the solution of contrast layer, resulting after drying in a dry thickness of 84 mg/m². After drying, the ageing, imaging, processing and optical density measurements are carried out in the same way as described in Comparative Example 1.

The obtained results are summerized in Table 1.

### Invention Example 9

The preparation of printing plate precursor of Invention Example 9 is carried out in the same way as described for Invention Example 5, with the exception that the 84 mg/m² of the infrared absorbing Dye-1 was omitted in the image recording layer and added to the contrast layer in the same amount. After drying, the ageing, imaging, processing and optical density measurements are carried out in the same way as described in Comparative Example 1.

The obtained results are summerized in Table 1.

### Comparative Example 2

The lithographic aluminum support as prepared in Comparative Example 1 was coated at a wet thickness of 30 g/m² with an aqueous coating solution. This aqueous coating solution was adjusted to a pH of 3.6 with ammonia and comprises the following ingredients of which the dry thicknesses in the image recording layer composition are also given below:
630 mg/m² of particles of a copolymer of styrene and acrylonitrile (weight ratio 60/40) having an average particle size of 65 nm and stabilized by an anionic wetting agent,
42 mg/m² of a Cu-phthalocyanine pigment CABOJET 250, commercially available from CABOT CORPORATION.

After drying, a separate layer was coated onto this image recording layer at a wet thickness of 20 g/m² with an aqueous coating solution. This aqueous coating solution was adjusted to a pH of 3.3 with HCl and comprises the following ingredients of which the dry thicknesses in the contrast layer composition are also given below:
84 mg/m² of a high molecular weight polyacrylic acid GLASCOL E15, commercially available from ALLIED COLLOIDS, and
84 mg/m² of infrared absorbing Dye-1.

After drying, the ageing, imaging, processing and optical density measurements are carried out in the same way as described in Comparative Example 1.

The obtained results are summerized in Table 1.

TABLE 1

| | | | Non-image | Non-image |
|---|---|---|---|---|
| | pH of | | density after | density after |
| Example | contrast | Image | ageing at | ageing at |
| number | layer | density | 7 days/RT | 7 d/35° C./80% RH |
| Comparative | n/a | 0.68 | 0.063 | 0.610 |
| Example 1 | | | | |
| Invention | 2.5 | 0.62 | 0.000 | 0.149 |
| Example 1 | | | | |
| Invention | 2.5 | 0.64 | 0.000 | 0.186 |
| Example 2 | | | | |
| Invention | 3.6 | 0.83 | 0.013 | 0.242 |
| Example 3 | | | | |
| Invention | 2.5 | 0.88 | 0.012 | 0.210 |
| Example 4 | | | | |
| Invention | 2 | 0.74 | 0.030 | 0.155 |
| Example 5 | | | | |
| Invention | 1 | 0.52 | 0.007 | 0.140 |
| Example 6 | | | | |
| Invention | 2 | 0.81 | 0.000 | 0.120 |
| Example 7 | | | | |
| Invention | 2 | 0.76 | 0.025 | 0.109 |
| Example 8 | | | | |
| Invention | 2 | 0.52 | 0.018 | 0.051 |
| Example 9 | | | | |
| Comparative | 3.3 | 0.37 | 0.627 | 0.721 |
| Example 2 | | | | |

The Examples in Table 1 demonstrate that the optical density in the non-image areas after ageing 7 days at room temperature and also after ageing 7 days at 35° C. and 80% relative humidity is highly reduced when the colorant is present in a contrast layer. In some situations the optical density is even undistinguishable from zero, indicating no staining at all.

This reduction of staining can further be improved by lowering the pH of the coating solution of the contrast layer.

This reduction of staining can further be improved by moving the infrared absorbing dye from the image recording layer to the contrast layer, and also by adding a polymer comprising carboxylic acid groups to the contrast layer. In both situations, the adsorption of hydrophobic compounds on the hydrophilic surface of the support after processing is reduced, resulting in less staining.

The comparative examples demonstrate that staining occurs when the colorant is present in the image recording layer. Also when the infrared absorbing dye and the hydrophilic binder are moved from the image recording layer to the contrast layer, staining occurs when the colorant is present in the image recording later.

1. A heat sensitive lithographic printing plate precursor comprising in the order given (i) a lithographic base having a hydrophilic surface, (ii) an image recording layer comprising hydrophobic thermoplastic polymer particles and (iii) a contrast layer, said precursor comprising an infrared absorbing compound present in at least one of said image recording layer or contrast layer, characterised in that said contrast layer further comprises a colorant capable of providing a visible image after exposure and development of the precursor and wherein said image recording layer is substantially free of said colorant.

2. A heat sensitive precursor according to claim 1 wherein said colorant is a pigment.

3. A heat sensitive precursor according to claim 2 wherein said pigment is a self-dispersing pigment or a surface-treated pigment.

4. A heat sensitive precursor according to claim 3 wherein said pigment has anionic or acidic groups on the surface.

5. A heat sensitive precursor according to claim 1, wherein said contrast layer further comprises a hydrophilic polymer and/or a surfactant.

6. A heat sensitive precursor according to claim 5 wherein said hydrophilic polymer comprises anionic groups or non-ionic groups.

7. A heat sensitive precursor according to claim 5 wherein said surfactant is an anionic or non-ionic surfactant.

8. A heat sensitive precursor according to claim 5 wherein said hydrophilic polymer is a polymer or copolymer of polyvinylalcohol, poly(meth)acrilic acid, polystyrene sulphonic acid, poly(meth)acrylamide, polyhydroxyethyl(meth)acrylate, polyvinylmethylether, polyvinylpyrrolidone, polysaccharide, gelatine, arabic gum, alginic acid or salts thereof.

9. A heat sensitive precursor according to claim 1 wherein said hydrophobic thermoplastic polymer particles comprise a copolymer of styrene and at least 5 mole % of a nitrogen-containing monomer.

10. A method of making a lithographic printing plate precursor comprising the steps of
providing a lithographic base having a hydrophilic surface,
coating on said hydrophilic surface an image recording layer comprising hydrophobic thermoplastic polymer particles, and
coating on said image recording layer a contrast layer,
wherein said precursor comprising an infrared absorbing compound present in at least one of said image recording layer or contrast layer,
wherein said contrast layer further comprising a colorant, capable of providing a visible image after exposure and development of the precursor, and
wherein said image recording layer is substantially free of said colorant.

11. A method of making a lithographic printing plate comprising the steps of
providing a lithographic printing plate precursor according to claim 1 wherein
exposing the precursor to IR-light, thereby inducing coalescence of the thermoplastic polymer particles at exposed areas of the image recording layer; and developing the precursor whereby the image recording layer and the contrast layer are removed from the support on the non-exposed areas.

12. A heat sensitive precursor according to claim 2, wherein said contrast layer further comprises a hydrophilic polymer and/or a surfactant.

13. A heat sensitive precursor according to claim 3, wherein said contrast layer further comprises a hydrophilic polymer and/or a surfactant.

14. A heat sensitive precursor according to claim 4, wherein said contrast layer further comprises a hydrophilic polymer and/or a surfactant.

15. A heat sensitive precursor according to claim 2 wherein said hydrophobic thermoplastic polymer particles comprise a copolymer of styrene and at least 5 mole % of a nitrogen-containing monomer.

16. A heat sensitive precursor according to claim 3 wherein said hydrophobic thermoplastic polymer particles comprise a copolymer of styrene and at least 5 mole % of a nitrogen-containing monomer.

17. A heat sensitive precursor according to claim 4 wherein said hydrophobic thermoplastic polymer particles comprise a copolymer of styrene and at least 5 mole % of a nitrogen-containing monomer.

18. A heat sensitive precursor according to claim 5 wherein said hydrophobic thermoplastic polymer particles comprise a copolymer of styrene and at least 5 mole % of a nitrogen-containing monomer.

19. A heat sensitive precursor according to claim 6 wherein said hydrophobic thermoplastic polymer particles comprise a copolymer of styrene and at least 5 mole % of a nitrogen-containing monomer.

20. A heat sensitive precursor according to claim 7 wherein said hydrophobic thermoplastic polymer particles comprise a copolymer of styrene and at least 5 mole % of a nitrogen-containing monomer.

21. A heat sensitive precursor according to claim 8 wherein said hydrophobic thermoplastic polymer particles comprise a copolymer of styrene and at least 5 mole % of a nitrogen-containing monomer.

22. A method of making a lithographic printing plate comprising the steps of
providing a lithographic printing plate precursor according to claim 4 wherein;
exposing the precursor to IR-light, thereby inducing coalescence of the thermoplastic polymer particles at exposed areas of the image recording layer; and developing the precursor whereby the image recording layer and the contrast layer are removed from the support on the non-exposed areas.
